(19) United States
(12) Patent Application Publication
(10) Pub. No.: US 2025/0381835 A1
(43) Pub. Date: Dec. 18, 2025

(54) AN IN-WHEEL ELECTRIC MOTOR

(71) Applicant: PROTEAN ELECTRIC LIMITED, Farnham Surrey (GB)

(72) Inventors: Andrew Whitehead, Farnham Surrey (GB); Richard Ford, Farnham Surrey (GB); Marcos Zakakiotis, Farnham Surrey (GB)

(21) Appl. No.: 18/878,400

(22) PCT Filed: May 26, 2023
(86) PCT No.: PCT/GB2023/051400

§ 371 Date: Dec. 23, 2024

(30) Foreign Application Priority Data
Jun. 25, 2022 (GB) 2209339.7

(51) Int. Cl. B60K 7/00; H02K 7/108

(52) U.S. Cl. CPC B60K 7/0007; H02K 7/108; B60K 2007/0038

(57) ABSTRACT

An in-wheel electric motor for a vehicle comprising a stator, a first rotor arranged to be housed within a wheel of the vehicle, and coupling means for selectively coupling the first rotor to the wheel of the vehicle and decoupling the first rotor to the wheel, such that when the first rotor is coupled to the wheel, the first rotor is arranged to rotate with the wheel, and when the first rotor is decoupled from the wheel, the first rotor is arranged to be stationary with respect to the stator when the wheel rotates relative to the stator.

The present invention relates to an in-wheel electric motor, in particular an in-wheel electric motor for a vehicle.

With increased interest being placed in environmentally friendly vehicles there has, perhaps unsurprisingly, been a corresponding increase in interest in the use of electric vehicles.

Electric vehicles typically use an electric motor to provide both drive for the vehicle and regenerative braking for stopping the vehicle. To effect regenerative braking rotary motion of drive wheels connected to an electric motor is converted into electric energy, which involves consumption of kinetic energy and provides a braking force to the drive wheels. The regenerated electric energy can be stored in a device such as a battery and subsequently used to provide power to the electric motor.

However, currently it is impractical for electric vehicles to provide full brake torque on all wheels through regenerative braking alone. This gives rise to a need for an additional braking system, for example a friction brake attached to a rotor of an in-wheel electric motor, which in turn is attached to a wheel of a vehicle.

However, to reduce electric motor losses, situations may arise where it would be desirable to stop the electric motor rotor from spinning under certain conditions. However, if the primary vehicle friction braking system is attached to the electric motor rotor, the decoupling of the rotor from the wheel will result in the vehicle failing to meet legal braking requirements.

It is desirable to improve this situation.

In accordance with an aspect of the present invention there is provided an in-wheel electric motor, a vehicle and a method according to the accompanying claims.

The invention provides the advantage of allowing electric motor losses to be reduced when a vehicle's drive electric motor is not required to provide drive. For example, by decoupling a rotor of the electric motor from a wheel of a vehicle, thereby allowing the rotor to remain substantially stationary with respect to a stator of the electric motor while the wheel of the vehicle is rotating, while also allowing the rotation of the rotor to be locked to that of the wheel during a braking operation. The invention also provides the advantages of providing reduced noise, vibration while the rotor of the electric motor is decoupled from a wheel and provide a failure mode should a problem occur with the electric motor.

The present invention will now be described, by way of example, with reference to the accompanying drawings, in which:

FIG. 1 illustrates a first embodiment of an electric motor according to an embodiment of the present invention;

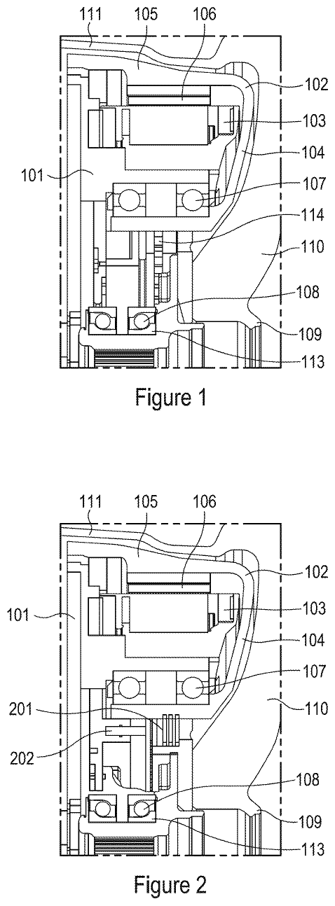

FIG. 2 illustrates a second embodiment of an electric motor according to an embodiment of the present invention;

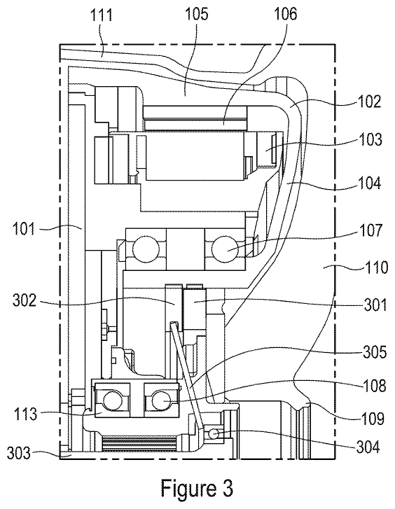

FIG. 3 illustrates a third embodiment of an electric motor according to an embodiment of the present invention;

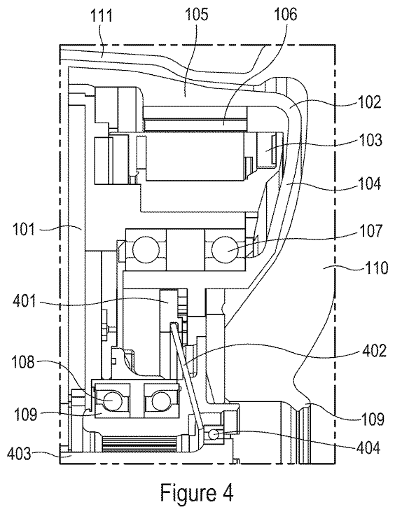

FIG. 4 illustrates a fourth embodiment of an electric motor according to an embodiment of the present invention;

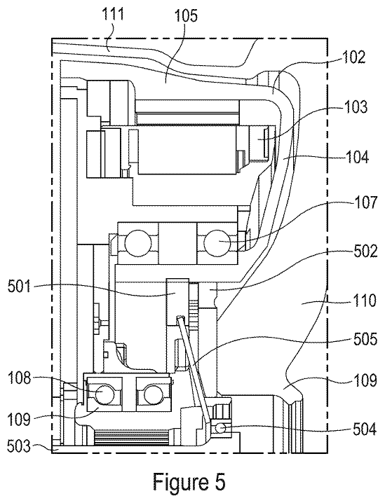

FIG. 5 illustrates a fifth embodiment of an electric motor according to an embodiment of the present invention;

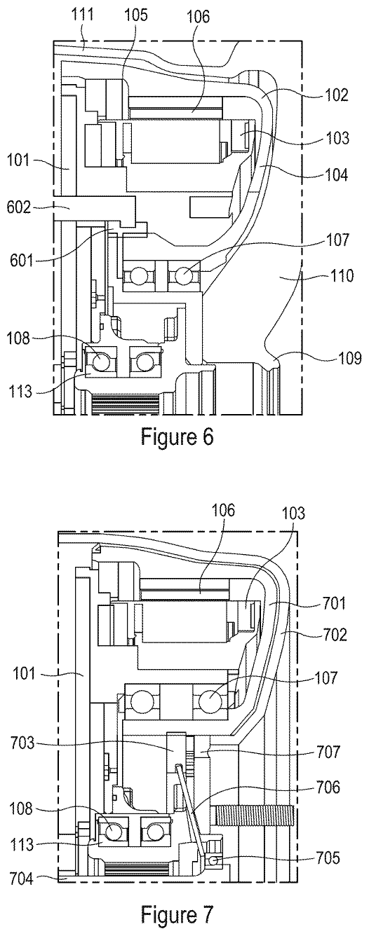

FIG. 6 illustrates a sixth embodiment of an electric motor according to an embodiment of the present invention;

FIG. 7 illustrates a seventh embodiment of an electric motor according to an embodiment of the present invention.

FIG. 1 illustrates a first example of an in-wheel electric motor in accordance with an embodiment of the present invention. The electric motor includes a stator 101 and a rotor 102. The stator 101 is arranged to be coupled to a vehicle (not shown). The stator 101 includes electrical coil 103. The coils 103 are formed on stator tooth laminations to form coil windings.

The rotor 102 comprises a front portion 104 and a cylindrical portion 105 forming a cover, which substantially surrounds the stator 101. The rotor 102 includes a plurality of permanent magnets 106 arranged around the inside of the cylindrical portion 105.

The magnets 106 are in close proximity to the coil windings 103 on the stator 101 so that magnetic fields generated by the coils interact with the magnets 106 arranged around the inside of the cylindrical portion 105 of the rotor 102 to cause the rotor 102 to rotate when an alternating current is applied to the coil windings 102. As the permanent magnets 106 are utilized to generate a drive torque for driving the electric motor, the permanent magnets are typically called drive magnets.

The rotor 102 is attached to the stator 101 by a first bearing 107 with a wheel 109 of the vehicle being attached to the vehicle, either directly or indirectly via the stator 101, by a second bearing 108. The first bearing 107 may include a plurality of bearings, similarly the second bearing 108 may also include a plurality of bearings. As is well known to a person skilled in the art, the wheel 109 includes a front portion 110 and a cylindrical portion 111 forming a cover, which substantially surrounds the rotor 102 and upon which a tyre (not shown) is mounted on the outer surface of the cylindrical portion 111.

The first bearing 107 comprises two parts, a first part fixed to inner axial surface of the stator 101 and a second part fixed to an outer axial surface of the rotor 102. The rotor 102 is thus rotationally fixed to the stator 101 with which it is to be used via the first bearing 107 to allow the rotor 102 to rotate relative to the stator 101.

The second bearing 108 is typically a standard bearing block, for example a wheel hub. The second bearing 108 comprises two parts, a first part, which in the present embodiment is fixed to the stator 101 and a second part 113 fixed to the wheel 109. As such, the first part of the second bearing 108 is fixed to the vehicle, either directly or via the stator 101, while the second part of the second bearing 108 is fixed to the wheel. Consequently, the second part 113 of the second bearing 108 and the wheel form a single entity, accordingly any reference to the wheel includes the second part 113 of the second bearing 108. The wheel 109 is thus rotationally fixed to the vehicle with which it is to be used via the second bearing 108.

The rotor 102 includes engagement means that includes a selector sleeve having a sliding pin 114, where the sliding pin 114 is arranged to slide from a first position within the rotor 102 to a second position that extends axially away from the stator and engages with an aperture (not shown) formed on the wheel 109, thereby coupling the rotor 102 and the wheel 109. As such, when the pin 114 is in the first position the rotor 102 is decoupled from the wheel 109 and the rotor 102 is arranged to be stationary with respect to the stator 101 when the wheel 109 rotates relative to the stator.

When the pin 114 is in the second position the rotor 102 is coupled to the wheel 109 and the movement of the rotor 102 and wheel 109 are synchronised so there is a one to one correspondence between the angle of rotation of the rotor and the wheel.

Consequently, when the rotor 102 is coupled to the wheel 109, the movement of the first bearing 107 and the second bearing 108 are synchronised and when the rotor 102 is decoupled from the wheel 109, the first bearing 107 is stationary when the second bearing 108 is rotating.

When the rotor 102 is decoupled from the wheel 109, to allow the rotor 102 to be coupled to the wheel 109, to avoid damage to either the rotor or the wheel, preferably the rotor is arranged to rotate in synchronisation with the wheel, for example using motor torque generated by current flowing through the coil windings 102, as described above. Once the rotation of the rotor and wheel are synchronised the pin 114 is arranged to be moved from the first position to the second position.

Preferably the movement of the pin 114 between the first position and the second position is performed via an activation circuit (not shown) in response to an electrical signal received from a control unit (not shown). For example, the activation circuit may include an electromagnet that controls the position of the pin 114 in response to an electrical signal. To aid the movement of the pin 114 back into the selector sleeve when the rotor 102 and the wheel 109 are to be decoupled, the selector sleeve includes one or more return springs such that the pin 114 is sprung loaded within the selector sleeve.

Preferably, the stator 101 also includes a mechanism for maintaining the rotor 102 stationary with respect to the stator 101 when the rotor 102 is decoupled from the wheel 109. For example, the mechanism may include an activation circuit (not shown) for applying a current to the coil windings 103 mounted on the stator 101 for generating a magnetic field that interacts with the magnets 106 mounted on the rotor 102 to inhibit movement of the rotor 102 relative to the stator 101. Preferably activation of this mechanism is in response to an electrical signal received from the control unit (not shown). However, the mechanism for maintaining the rotor 102 stationary may be performed by any means, mechanical or electrical.

Although FIG. 1 illustrates engagement means that includes a selector sleeve having a sliding pin 114 for coupling and decoupling the rotor 102 from the wheel 109, any form of engagement means may be used. For example, a face dog, a radial dog, a clutch, a cone clutch, synchronisers.

By way of illustration, FIGS. 2 to 6 illustrate alternative embodiments an electric motor in accordance with an aspect of the present invention, where alternative engagement means are represented in each figure. The same reference numerals are used within the different figures to represent the same features.

FIG. 2 illustrates a second example of an electric motor in accordance with an embodiment of the present invention, where the engagement means includes a wet clutch. The wet clutch includes a wet clutch pack 201 mounted between an inner axial surface of the rotor 102 and an opposite axial surface on the wheel 109 with a hydraulic activated piston 202 mounted on the stator 101 for engaging and disengaging the wet clutch pack 201, thereby allowing the rotor 102 to be coupled and decoupled to the wheel 109. Activation of the piston 202 is performed in response to an electrical signal received from the control unit.

FIG. 3 illustrates a third example of an electric motor in accordance with an embodiment of the present invention, where the engagement means includes a dry clutch. The dry clutch includes a dry clutch plate 301 mounted between on an inner axial surface of the rotor 102 and a radial wall of the wheel 109 where activation of the dry clutch plate 301 is performed via a clutch apply plate 302, a diaphragm spring 305, an actuator rod 303 and an axial thrust bearing 304, thereby allowing the rotor 102 to be coupled and decoupled to the wheel 109. Activation of the actuator rod 303 is preferably performed in response to an electrical signal received from the control unit.

FIG. 4 illustrates a fourth example of an electric motor in accordance with an embodiment of the present invention, where the engagement means includes a centrally actuated pin arrangement. The centrally actuated pin arrangement includes a selector sleeve 401 having a sliding pin, where the sliding pin is arranged to slide from a first position within the rotor 102 to a second position that extends axially away from the stator and engages with an aperture formed on the wheel 109, where activation of the pin is performed via a diaphragm spring 402, an actuator rod 403 and an axial thrust bearing 404, thereby allowing the rotor 102 to be coupled and decoupled to the wheel 109. Activation of the actuator rod 403 is preferably performed in response to an electrical signal received from the control unit.

FIG. 5 illustrates a fifth example of an electric motor in accordance with an embodiment of the present invention, where the engagement means includes a face dog arrangement. The face dog arrangement includes a selector sleeve 501 having a face dog, where the face dog is arranged to slide from a first position within the rotor 102 to a second position that extends axially away from the stator and engages with a corresponding face dog 502 formed on the wheel 109 or the second part 113 of the second bearing 108. The actuation of the selector sleeve between the first position and the second position is performed via an actuator rod 503, a thrust bearing 504 and a diaphragm spring 505, thereby allowing the rotor 102 to be coupled and decoupled to the wheel 109. Activation of the actuator rod 503 is preferably performed in response to an electrical signal received from the control unit.

FIG. 6 illustrates a sixth example of an electric motor in accordance with an embodiment of the present invention, where the engagement means includes a sliding sleeve arrangement. The sliding sleeve arrangement includes a sliding selector sleeve 601 having a radial dog formed on an inner axial surface of the sliding selector sleeve 601. The sliding selector sleeve 601 is arranged to slide from a first position within the rotor 102 to a second position that extends axially away from the stator, where as illustrated in FIG. 6, when the sliding selector sleeve 601 is in the first position the radial dog formed on the sliding selector sleeve 601 is arranged to engage with a corresponding radial dog formed on the wheel 109 or the second part 113 of the second bearing 108, when the sliding selector sleeve 601 is in the second position the radial dog formed on the sliding selector sleeve 601 is arranged to disengage from the corresponding radial dog formed on the wheel 109 or the second part 113 of the second bearing 108, thereby allowing the rotor 102 to be coupled and decoupled to the wheel 109. Activation of the sliding selector sleeve 601 between the first position and the second position is preferably performed in response to an electrical signal received from the control unit.

Preferably, a disc brake (not shown) is mounted on the cylindrical portion 105 of the rotor 102 for each of the above embodiments for providing a braking torque to the vehicle, such that when the rotor 102 is coupled to the wheel 109 via the engagement means, any brake torque applied to the rotor 102 is correspondingly applied to the wheel 109. Alternatively, a disc brake (not shown) may be mounted on a cylindrical portion of the wheel 109.

In a further embodiment of the present invention, as illustrated in FIG. 7, the rotor may include an inner rotor 701 and an outer rotor 702. The inner rotor 701 is attached to the stator 101 by the first bearing 107 with the outer rotor 702 being attached to the vehicle, either directly or indirectly via the stator 101, by the second bearing 108. The same reference numerals are used within FIG. 7 to represent the same features as shown in FIG. 1.

The inner rotor 701 comprises a front portion and a cylindrical portion forming a cover, which substantially surrounds the stator 101. The inner rotor 701 includes a plurality of permanent magnets 106 arranged around the inside of the cylindrical portion.

The magnets 106 are in close proximity to coil windings 103 mounted on the stator 101 so that magnetic fields generated by the coils interact with the magnets 106 arranged around the inside of the cylindrical portion of the inner rotor 701 to cause the inner rotor 701 to rotate when an alternating current is applied to the coil windings 102. As the permanent magnets 106 are utilized to generate a drive torque for driving the electric motor, the permanent magnets are typically called drive magnets.

The outer rotor 702 is arranged to be coupled, directly or indirectly, to a wheel (not shown) of the vehicle, for example via one or more bolts or other coupling means, and coupled to the second part 113 of the second bearing 108.

The inner rotor 701 includes engagement means for selectively coupling the inner rotor 701 to the outer rotor 702 and decouple the inner rotor 701 to the outer rotor 702, such that when the inner rotor 701 is coupled to the outer rotor 702, the wheel is arranged to rotate with the inner rotor 701 and when the inner rotor is decoupled from the outer rotor 702, the inner rotor 701 is arranged to be stationary with respect to the stator 101 while the wheel rotates relative to the inner rotor 701. As with the embodiments of the present invention having a single rotor 102, as illustrated in FIGS. 1 to 6, any form of engagement means may be used. For example, a face dog, a radial dog, a clutch, a cone clutch, synchronisers.

For the purposes of the present embodiment, the engagement means includes a face dog arrangement. The face dog arrangement includes a selector sleeve 703 having a face dog, where the face dog is arranged to slide from a first position within the inner rotor 701 to a second position that extends axially away from the stator 101 and engages with a corresponding face dog 707 formed on the outer rotor 702 or the second part 113 of the second bearing 108. The actuation of the selector sleeve 703 between the first position and the second position is performed via an actuator rod 704, a thrust bearing 705 and a diaphragm spring 706, thereby allowing the inner rotor 701 to be coupled and decoupled to the outer rotor 702. Activation of the actuator rod 704 is preferably performed in response to an electrical signal received from the control unit.

Preferably, a disc brake (not shown) is mounted on a cylindrical portion of the outer rotor 702 for providing a braking torque to the vehicle, such that when the inner rotor 701 is coupled to the outer rotor 702 via the engagement means, any brake torque applied to the inner rotor 701 is correspondingly applied to the outer rotor 702 and accordingly the wheel of the vehicle.

1. An in-wheel electric motor for a vehicle comprising:
a stator,
a first rotor arranged to be housed within a wheel of the vehicle, and
coupling means for selectively coupling the first rotor to the wheel of the vehicle and decoupling the first rotor to the wheel, such that when the first rotor is coupled to the wheel, the first rotor is arranged to rotate with the wheel, and when the first rotor is decoupled from the wheel, the first rotor is arranged to be stationary with respect to the stator when the wheel rotates relative to the stator.

2. An in-wheel electric motor according to claim 1, wherein the coupling means is arranged to selectively couple the first rotor to the wheel of the vehicle and decouple the first rotor to the wheel in response to an electrical signal.

3. An in-wheel electric motor according to claim 1, wherein the coupling means includes a face dog tooth interface or a radial dog tooth interface for coupling the first rotor to the wheel.

4. An in-wheel electric motor according to claim 1, wherein the coupling means includes a pin for coupling the first rotor to the wheel.

5. An in-wheel electric motor according to claim 4, wherein the pin is arranged to be placed in an aperture on the wheel when the rotor is coupled to the wheel.

6. An in-wheel electric motor according to claim 1, wherein the coupling means includes a clutch for coupling the first rotor to the wheel.

7. An in-wheel electric motor according to claim 1, further comprising means for maintaining the first rotor stationary with respect to the stator when the first rotor is decoupled from the wheel.

8. An in-wheel electric motor according to claim 2, wherein the means for maintaining includes an activation circuit for applying a current to coil windings mounted on the stator for generating a magnetic field that interacts with the first rotor to inhibit movement of the first rotor relative to the stator.

9. An in-wheel electric motor according to claim 1, further comprising a first bearing to allow the wheel to rotate relative to the stator and a second bearing to allow the first rotor to rotate relative to the stator.

10. An in-wheel electric motor according to claim 4, wherein when the first rotor is coupled to the wheel, the movement of the first bearing and the second bearing are synchronised.

11. An in-wheel electric motor according to claim 4, wherein when the first rotor is decoupled from the wheel, the second bearing is stationary when the first bearing is rotating.

12. An in-wheel electric motor according to claim 1, wherein the first rotor includes an inner rotor and an outer rotor.

13. An in-wheel electric motor according to claim 12, wherein:
the outer rotor is arranged to be coupled to the wheel, and
the coupling means is arranged to selectively couple the inner rotor to the outer rotor and decouple the inner rotor to the outer rotor, such that when the inner rotor is coupled to the outer rotor, the wheel is arranged to rotate with the inner rotor and when the inner rotor is decoupled from the outer rotor, the inner rotor is arranged to be stationary with respect to the stator while the wheel rotates relative to the inner rotor.

14. An in-wheel electric motor according to claim 13, further comprising a brake disc attached to the outer rotor.

15. A vehicle comprising:
a wheel, and
an in-wheel electric motor, the in-wheel electric motor comprising:
a stator,
a first rotor arranged to be housed within a wheel of the vehicle, and
coupling means for selectively coupling the first rotor to the wheel of the vehicle and decoupling the first rotor to the wheel, such that when the first rotor is coupled to the wheel, the first rotor is arranged to rotate with the wheel, and when the first rotor is decoupled from the wheel, the first rotor is arranged to be stationary with respect to the stator when the wheel rotates relative to the stator.

16. A method for an in-wheel electric motor for a vehicle, wherein the in-wheel electric motor includes a stator, a first rotor arranged to be housed within a wheel of the vehicle, and coupling means for selectively coupling the first rotor to the wheel of the vehicle and decoupling the first rotor to the wheel, such that when the first rotor is coupled to the wheel, the wheel is arranged to rotate with the first rotor and when the first rotor is decoupled from the wheel, the first rotor is arranged to be stationary with respect to the stator while the wheel rotates relative to the first rotor, the method comprising coupling the first rotor to the wheel and decoupling the first rotor from the wheel in response to the receipt of an actuation signal.

17. An in-wheel electric motor according to claim 15, wherein the coupling means includes a face dog tooth interface or a radial dog tooth interface for coupling the first rotor to the wheel.

18. An in-wheel electric motor according to claim 15, wherein the coupling means includes a pin for coupling the first rotor to the wheel.

19. An in-wheel electric motor according to claim 15, wherein the coupling means includes a clutch for coupling the first rotor to the wheel.

20. An in-wheel electric motor according to claim 15, further comprising means for maintaining the first rotor stationary with respect to the stator when the first rotor is decoupled from the wheel.
